(19) United States
(12) Patent Application Publication
(10) Pub. No.: US 2022/0215355 A1
(43) Pub. Date: Jul. 7, 2022

(54) METHOD FOR DIRECTLY TRANSMITTING ELECTRONIC COIN DATA RECORDS BETWEEN TERMINALS AND PAYMENT SYSTEM

(71) Applicant: GIESECKE+DEVRIENT ADVANCE52 GMBH, Munich (DE)

(72) Inventors: Florian GAWLAS, Munchen (DE); Tilo FRITZHANNS, Munchen (DE); Marco RUMMER, Munchen (DE); Wolfram SEIDEMANN, Munchen (DE); Maria VELEVA, Munchen (DE)

(21) Appl. No.: 17/594,419

(22) PCT Filed: Apr. 14, 2020
(86) PCT No.: PCT/EP2020/060446

§ 371 Date: Oct. 15, 2021

(30) Foreign Application Priority Data
Apr. 15, 2019 (DE) 10 2019 002 732.9

(51) Int. Cl. G06Q 20/06; G06Q 20/38; H04L 9/00

(52) U.S. Cl. CPC G06Q 20/065; G06Q 20/383; H04L 2209/56; H04L 2209/04; H04L 9/008

(57) ABSTRACT

A method for directly transmitting an electronic coin data record between first and second terminals, with the following steps carried out by the second terminal: receiving the electronic coin data record from the first terminal, wherein the at least one electronic coin data record includes a monetary amount and a concealment amount; generating a modified electronic coin data record using the received electronic coin data record; masking the modified electronic coin record by applying a homomorphic one-way function to the modified electronic coin record in order to obtain a masked modified electronic coin record; sending a registration request for the masked modified electronic coin data record to a monitoring entity. A currency system and a payment system includes a decentrally controlled database in which masked electronic coin data records are stored; and a direct transaction layer including at least two terminals in which the method can be carried out.

### TECHNICAL FIELD OF THE INVENTION

The invention relates to a device for directly transmitting electronic coin data records between terminals. The invention also relates to a payment system between at least two terminals and a monitoring entity.

### TECHNICAL BACKGROUND OF THE INVENTION

Security of payment transactions and the associated payment transaction data means protection of the confidentiality of the data exchanged; as well as protection of the integrity of the data exchanged; as well as protection of the availability of the exchanged data.

Conventional blockchain-based payment transactions, such as Bitcoin, represent a high level of protection of integrity. When electronic coin data records, also known as “coins”, change hands in a blockchain technology, a lot of information is published. Thus, such payment transactions, and in particular the data exchanged, are not completely confidential. In addition, the payment transactions are very computationally intensive and therefore energy consuming.

Therefore, instead of the confidential data, only the hash values of the confidential data are conventionally stored in a blockchain ledger. The corresponding plain text data must then be managed outside the blockchain. Such concepts have so far not been applicable to electronic coin data records because they do not have basic control functions, in particular (1) the recognition of methods of multiple spending, also known as double spending, and (2) the recognition of uncovered payments. In case (1) someone tries to output the same coin data record multiple times and in the second case someone tries to output a coin data record even though he or she has no credit (anymore).

From DE 10 2009 038 645 A1 and DE 10 2009 034 436 A1, systems for transmitting monetary amounts in the form of electronic data records are known, wherein payment with duplicates of the data record is prevented and a high degree of manipulation security is provided while complex structures and complex encryption and signing processes are required for the exchange. These systems turned out to be of little practical use.

WO 2016/200885 A1 describes a method for encrypting an amount transacted in a blockchain ledger, wherein the verifiability of the transaction is retained. A concealment amount is added to an input value. Then an output value is generated and encrypted. Both the input value and the output value are within a range of values, with a sum of any two values within the range not exceeding a threshold value. The sum of the encrypted input value and the encrypted output value may be zero. Range checks, so-called range proofs, are associated with each of the input values and the output value. These range checks prove that the input value and output value fall within the range of values. Every public key may be signed with a ring signature based on a public key of a recipient in the transaction. This process requires blockchain technology, which must be called after receiving a coin data record in order to validate the coin data record.

It is the object of the present invention to provide a method and a system wherein a payment transaction is configured to be secure but simple. In particular, anonymous direct payment between terminals such as tokens, smartphones, but also machines is to be provided. The coin data records are to be usable immediately after receipt. It is intended, that a plurality of coin data records can be combined with one another and/or split as desired by the user in order to enable flexible exchange. The exchanged coin data records should on the one hand be confidential to other system participants, but on the other hand allow each system participant to carry out basic accounting checks, in particular the recognition of multiple spending attempts and the recognition of attempts to pay with non-existent amounts.

### SUMMARY OF THE INVENTION

The objects set are achieved by the features of the independent claims. Further advantageous developments are described in the dependent claims.

The object is achieved in particular by a method for directly transmitting an electronic coin data record between a first and a second terminal, with the following steps carried out by the second terminal. Receiving the electronic coin data record from the first terminal, wherein the at least one electronic coin data record includes a monetary amount and a concealment amount. Generating a modified electronic coin data record using the received electronic coin data record. Masking the modified electronic coin record by applying a homomorphic one-way function to the modified electronic coin record in order to obtain a masked modified electronic coin record. Sending a registration request for the masked modified electronic coin data record to a monitoring entity.

The registration request preferably comprises the masked modified electronic coin data record as the masked electronic coin data record to be registered and a masked received electronic coin data record for the received electronic coin data record as the already registered masked electronic coin data record.

In the step of generating

a modified electronic coin data record to be switched may be generated from the received electronic coin data record, or
the received electronic coin data record may be split into at least two split modified electronic coin data records, or

the received electronic coin data record as the first electronic coin data record and at least one second electronic coin data record may be joined to form the joined modified electronic coin data record.

The masked, modified electronic coin data record may thus be a masked electronic coin data record—which is either split, joined, or to be switched.

Accordingly, a registration request preferably comprises:

exactly one masked electronic coin data record to be registered and exactly one registered masked electronic coin data record, or
at least two masked split modified electronic coin data records to be registered (and the masked received electronic coin data record), or
at least two registered masked electronic coin records (one of which is the masked received electronic coin record and the masked joined electronic coin record).

Advantageously, the masked received electronic coin data record is obtained by the second terminal from the received electronic coin data record by applying the homomorphic one-way function.

In the step of generating, particularly advantageously the following is carried out for the different modifications. The modified electronic coin data record to be switched may be generated from the received electronic coin data record, wherein

a concealment amount is generated for the modified electronic coin data record using a received concealment amount of the received electronic coin data record, and
the received monetary amount of the received electronic coin data record is used as a monetary amount for the modified electronic coin data record.

The received electronic coin data record may be split into at least two electronic partial coin data records, wherein

the received monetary amount corresponds to the sum of the monetary amounts of the at least two electronic partial coin data records, and
in particular, the sum of the concealment amounts of the at least two electronic partial coin data records correspond to the concealment amount of the received electronic coin data record.

The received electronic coin data record as a first electronic coin data record and at least one second electronic coin data record may be joined to form the modified joined electronic coin data record by

calculating a concealment amount for the modified electronic coin data record by forming the sum of the respective concealment amounts of the first and second electronic coin data records, and
calculating the monetary amount for the modified electronic coin data record by forming the sum of the respective monetary amounts of the first and the second electronic coin data records.

After the (transmitted) electronic coin data record has been received in the second terminal, the coin data record is switched, split or joined accordingly. Switching the transmitted electronic coin data record to a further electronic coin data record, namely the electronic coin data record to be switched; or splitting the transmitted electronic coin data record into a further (second) electronic coin data record; or joining the transmitted electronic coin data record with another electronic coin data record to form a further electronic coin data record, namely the joined electronic coin data record. The further (or modified) electronic coin data record is masked. In embodiments, either only switching or only splitting or joining may be used in terminals, but the terminal preferably selects from one of the three steps.

The terminal sends the registration request to the monitoring entity which stores valid masked electronic coin data records for electronic coin data records. Terminals such as the second terminal may alternatively or additionally (for example before further use) check the validity of an electronic coin data record—in particular the received one—by sending the masked electronic coin data record to the monitoring entity in a validity request. The monitoring entity responds to the validity request (positively or negatively) on the basis of the stored valid masked electronic coin data records.

Sending of the registration request (and thus the step of registering in the monitoring entity) is preferably carried out when the terminal is connected to the monitoring entity. In an alternative, the steps described may also initially be carried out without the step of sending the registration request (and of registering at the monitoring entity) being carried out. The steps of receiving the electronic coin record and sending the registration request are independent of one another. The steps of receiving the electronic coin data record and sending the registration request may, in particular, be carried out independently of one another at different times (e.g. receive now and register later/(the day after) tomorrow).

When switching the transmitted coin data record, in one embodiment, the monetary amount of the transmitted electronic coin data record from the first terminal corresponds to the monetary amount of the further electronic coin data record. When splitting the transmitted electronic coin data record, in one embodiment, the monetary amount of the transmitted electronic coin data record corresponds to the total monetary amount of the further electronic coin partial data records created from the transmitted electronic coin data record. When joining, in one embodiment, the total monetary amount of the transmitted electronic coin data record and the second electronic coin data record corresponds to the monetary amount of the joined electronic coin data record.

An electronic coin data record is, in particular, an electronic data record that represents a value of money (=monetary amount) and is colloquially referred to as “digital coin” or “electronic coin”. In the method, this monetary amount switches from a first terminal to another terminal. In the following, a monetary amount is understood to be a digital amount that can be credited to an account of a financial institution, for example, or can be exchanged for another means of payment. Therefore, an electronic coin data record represents cash in electronic form.

The terminal may have a plurality of electronic coin data records; for example, the plurality of coin data records may be stored in a data storage of the terminal. The data storage then represents, for example, an electronic wallet. The terminal will usually carry out the steps completely by itself, but it may call a terminal service (an external server entity) that carries out at least one (in particular exactly one or exactly two or all three) of the steps of generating, masking and sending for the terminal (preferably ‘generating and masking’ or ‘masking and sending’ or sending).

The terminal may, for example, be a passive device, such as a token, a mobile device such as a smartphone, a tablet computer, a computer, a server or a machine.

A method according to the invention in a monitoring entity that stores valid masked electronic coin data records, each of which is formed by applying a homomorphic one-way function to an electronic coin data record, wherein electronic coin data records include a monetary amount and a concealment amount, comprises in particular the steps of:

receiving a registration request comprising at least one masked electronic coin data record to be registered and at least one registered masked electronic coin data record;
checking the registration request received, wherein
it is checked whether the registered masked electronic coin data record of the registration request is stored as a valid masked electronic coin data record for transmitting in the monitoring entity, and
it is checked whether the masked electronic coin data records of the registration request are monetarily amount-neutral overall; and
   storing the masked electronic coin data record to be registered as a valid masked electronic coin data record, wherein the registered masked electronic coin data record of the registration request that was previously stored as valid is no longer valid.

Checking the monetary amount neutrality of the registration request (which is possible due to the homomorphic one-way function used) is preferably carried out without knowledge of the amount by forming the difference between the masked electronic coin data records.

In preferred methods, the monitoring entity receives, from an issuer entity, creation and/or deactivation requests including at least one masked electronic coin data record created or to be deactivated, in particular for an electronic coin data record newly issued by the issuer entity or an electronic coin data record withdrawn by the issuer entity.

The creation and/or deactivation request for a masked electronic coin data record may include a signature of the issuer for the masked electronic coin data record, wherein the signature of the masked newly created electronic coin data record is preferably stored in the monitoring entity.

An electronic coin data record may become invalid in the monitoring entity by marking or by deleting the corresponding masked electronic coin data record in the monitoring entity. Particularly preferably, the corresponding masked electronic coin data record or the corresponding electronic coin data record is also deactivated in the issuer entity

In particular, an electronic coin data record is unique and unambiguous, thereby already differing from a conventional data record. It is advantageously used in a security concept which may optionally include, for example, signatures or encryptions. In principle, an electronic coin data record should contain all data required for a receiving entity with regard to verification and forwarding to other entities. Additional communication between the terminals when exchanging the electronic coin data records is therefore basically not necessary, but may be used.

According to the invention, an electronic coin data record used for transmission between two terminals includes a monetary amount, that is a datum which represents a monetary value of the electronic coin data record, and a concealment amount, for example a random number. In addition, the electronic coin data record may include further metadata, for example which currency the monetary amount represents. An electronic coin data record is uniquely represented by these at least two data (monetary amount and concealment amount). Anyone who has access to these two data of a valid coin data record can use this electronic coin data record for payment. Knowing these two values (monetary amount and concealment amount) is therefore equivalent to owning digital money. This electronic coin data record is transmitted directly between two terminals, namely at least between the first and second terminals. In one embodiment of the invention, an electronic coin data record consists of these two data so that only the transmittance of the monetary amount and the concealment amount is necessary for exchanging digital money.

A corresponding masked electronic coin data record is associated with each electronic coin data record. The knowledge of a masked electronic coin data record does not allow someone to dispense the digital money represented by the electronic coin data record. This represents an essential difference between masked electronic coin data records and (unmasked) electronic coin data records and is an essential part of the present invention. The masked electronic coin data record is unique and can be clearly associated with an electronic coin data record, i.e. in a 1-to-1 relationship. The electronic coin data record is preferably masked by a computing unit of the terminal within the terminal which also has the at least one electronic coin data record. Alternatively, the masking can be carried out by a computing unit of the terminal which receives the electronic coin data record.

This masked electronic coin data record is obtained by applying a homomorphic one-way function, in particular a homomorphic cryptographic function. This function is a one-way function, i.e. a mathematical function that is “easy” to calculate in terms of complexity theory, but “difficult” to practically impossible to reverse. Here, a one-way function is also referred to as a function for which no reversal that can be practically carried out in a reasonable time and with reasonable effort is known. The calculation of a masked electronic coin data record from an electronic coin data record is thus comparable to the generation of a public key in an encryption method using a residue class group. Preferably, a one-way function is used which operates on a group in which the discrete logarithm problem is difficult to solve, such as a cryptographic method analogous to elliptical curve cryptography, ECC for short, from a private key of a corresponding cryptography method. The inverse function, i.e. the generation of an electronic coin data record from a masked electronic coin data record, is very time-consuming—equivalent to generating the private key from a public key in an encryption method over a residue class group. When sums and differences or other mathematical operations are mentioned in the present document, these are to be understood in the mathematical sense as the respective operations on the corresponding mathematical group, for example the group of points on an elliptical curve.

The one-way function is homomorphic, i.e. a cryptographic method that has homomorphic properties. Thus, mathematical operations can be carried out with the masked electronic coin data record and also be carried out in parallel on the (unmasked) electronic coin data record and therefore be reproduced. With the help of the homomorphic one-way function, calculations with masked electronic coin data records can be reproduced in the monitoring entity without the corresponding (unmasked) electronic coin data records being known there. Therefore, certain calculations with electronic coin data records, for example for processing the (unmasked) electronic coin data record (e.g., splitting or joining) can also be verified in parallel with the associated masked electronic coin data records, e.g. for validation checks or to check the legality of the respective electronic coin data record. The homomorphism properties apply at least to addition and subtraction operations so that splitting or combining (=joining) electronic coin data records can also be recorded in the monitoring entity by means of the correspondingly masked electronic coin data records and can be reproduced by end devices that are requesting and/or by the monitoring entity without knowledge of the monetary amount and the terminal that is executing.

The homomorphism property therefore makes it possible to record valid and invalid electronic coin data records on the basis of their masked electronic coin data records in a monitoring entity without knowledge of the electronic coin data records even if these electronic coin data records are processed (split, joined, switched). This ensures that no additional monetary amount has been created or that an identity of the terminal is recorded in the monitoring entity. Masking thus allows for a high level of security without giving any insight into the monetary amount or the terminal. This results in a two-layer payment system. On the one hand, there is the processing layer in which masked electronic data records are checked and, on the other hand, there is the direct transaction layer in which at least two terminals transmit electronic coin data records.

While the electronic coin data records are used for direct payment between two terminals, the masked coin data records are registered in the monitoring entity.

The step of switching the transmitted electronic coin data record comprises the following sub-steps:

generating an electronic coin data record to be switched in the second terminal from the transmitted coin data record, wherein
a concealment amount for the electronic coin data record to be switched is generated in the second terminal using a transmitted concealment amount of the transmitted electronic coin data record; and
the transmitted monetary amount of the transmitted electronic coin data record is used as the monetary amount for the electronic coin data record to be switched.

When the electronic coin data record is transmitted from the first terminal to the second terminal, two terminals thus have knowledge of the electronic coin data record. In order to prevent the first terminal that is sending from also using the electronic coin data record for payment at another (third) terminal, the transmitted electronic coin data record is switched from the first terminal to the second terminal. Switching may preferably be carried out automatically when an electronic coin data record is received. In addition, it may also be done on request, for example at a command from the first and/or second terminal.

In a preferred embodiment, generating comprises creating a concealment amount for the electronic coin data record to be switched, preferably using the concealment amount of the transmitted electronic coin data record in conjunction with a new concealment amount, for example a random number. Preferably, the concealment amount of the electronic coin data record to be switched is obtained as the sum of the concealment amount of the transmitted electronic coin data record and the random number that serves as the new, i.e. additional, concealment amount. Furthermore, the monetary amount of the transmitted electronic coin data record is preferably used as the monetary amount for the electronic coin data record to be switched. Thus, no additional money is generated and the monetary amounts of both coin data records are identical.

Registering after the step of switching results in the electronic coin data record sent by the first terminal to become invalid and to be correspondingly recognized as invalid in a second attempt to spend by the first terminal. The (further) coin data record generated by the second terminal becomes valid after the checks have been successfully completed.

When switching, also referred to as “switch”, the electronic coin data record received from the first terminal results in a new electronic coin data record, preferably with the same monetary amount, the so-called electronic coin data record to be switched. The new electronic coin data record is generated by the second terminal, preferably by using the monetary amount of the received electronic coin data record as the monetary amount of the electronic coin data record to be switched. A new concealment amount, for example a random number, is generated. After switching, the electronic coin data record received and the electronic partial coin data record to be switched are preferably masked in the terminal by applying the homomorphic one-way function to the electronic coin data record received and the electronic partial coin data record to be switched in order to accordingly obtain a masked electronic coin data record received and a masked electronic partial coin data record to be switched. Furthermore, additional information that is required for registering the switch of the masked electronic coin data record in the remote monitoring entity is preferably calculated in the terminal. The additional information preferably includes a range proof for the masked electronic coin data record to be switched and a range proof for the masked electronic coin record received. The range proof is proof that the monetary value of the electronic coin data record is not negative, the electronic coin data record is validly created and/or the monetary value and the concealment amount of the electronic coin data record are known to the creator of the range proof. In particular, the range proof serves to provide said proof(s) without revealing the monetary value and/or the concealment amount of the masked electronic coin data record. These range proofs are also called “zero knowledge range proofs”. Ring signatures are preferably used as range proof. The switch of the masked electronic coin data record is then registered in the remote monitoring entity.

This switching is necessary in order to invalidate (make invalid) the electronic coin data record received from the first terminal in order to avoid double spending. Because, as long as the electronic coin data record has not been switched, the first terminal can pass this received electronic coin data record to a third device since the first terminal has knowledge of the electronic coin data record and is therefore still in possession of it. Switching is made secure, for example, by adding a new concealment amount to the concealment amount of the electronic coin data record received, thereby obtaining a concealment amount that only the second terminal knows. Newly created concealment amounts must have high entropy since they are used as a dazzle factor for the corresponding masked electronic partial coin data records. Preferably, a random number generator on the terminal is used for this purpose. This protection can be tracked in the monitoring entity.

In the step of splitting the electronic partial coin data record of the second terminal is split into the first electronic partial coin data record and the second electronic partial coin data record. Splitting is preferably carried out, on the one hand, by determining a partial monetary amount and a partial concealment amount for the first electronic coin data record (each between 0 and the received monetary amount or concealment amount) and, on the other hand, by calculating the monetary amount of the second electronic partial coin data record as the difference between the received monetary amount and the partial monetary amount of the first electronic partial coin data record and calculating the concealment amount of the second electronic partial coin data record as the difference between the received concealment amount and the partial concealment amount of the first electronic partial coin data record. After the split, the electronic coin data record to be split, the first electronic partial coin data record and the second electronic partial coin data record are masked in the second terminal by respectively applying the homomorphic one-way function in order to accordingly obtain a masked electronic coin data record to be split, a masked first electronic partial coin data record and a masked second electronic partial coin data record. Furthermore, additional information that is required for registering the split of the masked electronic coin data record in the remote monitoring entity is calculated in the terminal. The additional information preferably includes a range proof of the masked electronic coin data record to be split, a range proof of the masked first electronic coin data record and a range proof of the masked second electronic coin data record. The range proof is proof that the monetary value of the electronic coin data record is not negative, the electronic coin data record has been validly created and/or the monetary value and the concealment amount of the electronic coin data record are known to the creator of the range proof. In particular, the range proof serves to provide said proof(s) without revealing the monetary value and/or the concealment amount of the masked electronic coin data record. These range proofs are also called “zero knowledge range proofs”. Preferably, ring signatures are used as range proof. The split of the masked electronic coin data record is then registered in the remote monitoring entity. In this way, the monetary amounts to be transmitted can be adapted to the corresponding needs. A terminal owner is not forced to always pass the entire monetary amount to another terminal.

Splitting and subsequently registering has the advantage that an owner of the at least one electronic coin data record is not forced to always transmit the entire monetary amount at once, but rather to transmit corresponding partial amounts. The monetary value can be split without restrictions as long as all electronic partial coin data records have a positive monetary amount that is less than the monetary amount of the electronic coin data record from which the split is made and the sum of the electronic partial coin data records is equal to the electronic partial coin data record to be split. Alternatively or additionally, fixed denominations may be used. Alternatively, the concealment amount may be generated outside the terminal and obtained via a (secure) communication channel Preferably, a random number generator on the terminal is used for this purpose. In order to keep track of all checks, the monitoring entity may, for example, note the partial steps of the monitoring entity in appropriate places, with markings, called flags, also being set for this purpose in order to document intermediate stages. After successfully completing the checks that are relevant for the split command, that is, if the markings are appropriately complete, the (masked) first electronic partial coin data record and the (masked) second electronic partial coin data record are preferably marked as valid. The (masked) electronic coin data record to be split automatically becomes invalid. Preferably, the monitoring entity communicates the result of executing the split command, i.e. which of the masked electronic coin data records involved are valid after executing the split command, to the “commanding” terminal.

In the step of joining electronic coin data records, a further electronic coin data record (joined electronic coin data record) is determined from a first and a second electronic coin data record. The concealment amount for the electronic coin data record to be joined is calculated by forming the sum of the respective concealment amounts of the first and second electronic coin data records. Furthermore, the monetary amount for the connected electronic coin data record is preferably calculated by forming the sum of the respective monetary amounts of the first and the second electronic coin data records.

After joining, the first electronic coin data record, the second electronic coin data record, and the electronic coin data record to be joined are masked in the (first and/or second) terminal by applying the homomorphic one-way function to the first electronic coin data record, the second electronic coin data record, and the electronic coin data record to be joined in order to accordingly obtain a masked first electronic coin data record, a masked second electronic coin data record, and a masked electronic coin data record to be joined. Furthermore, additional information required for registering the joining of the masked electronic coin data records in the remote monitoring entity is calculated in the terminal. Preferably, the additional information includes a range proof of the masked first electronic coin data record and a range proof of the masked second electronic coin data record. The range proof is proof that the monetary value of the electronic coin data record is not negative, the electronic coin data record has been validly created and/or the monetary value and the concealment amount of the electronic coin data record are known to the creator of the range proof. In particular, the range proof serves to provide said proof(s) without revealing the monetary value and/or the concealment amount of the masked electronic coin data record. These range proofs are also called “zero knowledge range proofs”. Preferably, ring signatures are used as range proof. The joining of the two masked electronic coin data records is then registered in the remote monitoring entity.

With the command or step of joining, two electronic coin data records can be combined. The monetary amounts as well as the concealment amounts are added. As with splitting, a validity of the two original coin data records may also be performed when joining.

A main distinguishing feature of this inventive concept from known solutions is that the monitoring entity only (that is, exclusively) keeps knowledge of the masked electronic coin data records and optionally a list of operations on or changes to the masked electronic coin data record. The actual payment transactions are not registered in the monitoring entity and are carried out in a direct transaction layer directly between terminals.

According to the invention, a two-layer payment system consisting of a direct payment transaction layer for the direct exchange of (unmasked) electronic coin data records and a monitoring layer, which may also be referred to as a “concealed electronic data record ledger”, is provided. Payment transactions are not recorded in the monitoring entity of the checking layer, but only masked electronic coin data records and operations thereon for the purpose of verifying the validity of (unmasked) electronic coin data records. This guarantees the anonymity of the participants in the payment system. The monitoring entity provides information about valid and invalid electronic coin data records, for example to avoid multiple spending of the same electronic coin data record or to verify the authenticity of the electronic coin data record as validly issued electronic money.

The first and/or second terminal may therefore transmit electronic coin data records to another terminal in the direct payment transaction layer without a connection to the checking entity, in particular when the terminal is offline.

Here, the first and/or second terminal may have a security element in which the electronic coin data records are securely stored. A security element is preferably a special computer program product, in particular in the form of a secured runtime environment within an operating system of a terminal, called Trusted Execution Environments, TEE, stored on a data storage, for example a mobile terminal, a machine, preferably an ATM. Alternatively, the security element is, for example, formed as special hardware, in particular in the form of a secured hardware platform module, called Trusted Platform Module, TPM, or as an embedded security module, eUICC, eSIM. The security element provides a trusted environment.

The communication between two terminals may be carried out in a wireless or wired, or, for example, also optical manner, preferably via QR code or barcode, and may be configured as a secure channel. The optical manner may include, for example, the steps of generating an optical encoding, in particular a 2D encoding, preferably a QR code, and reading in optical encoding. The exchange of the electronic coin data record is thus secured, for example, by cryptographic keys, for example a session key negotiated for an electronic coin data record exchange or a symmetrical or asymmetrical key pair.

By communicating between terminals, for example via security elements thereof, the exchanged electronic coin data records are protected from theft or manipulation. The security element level thus complements the security of established blockchain technology.

Moreover, it is advantageous that the electronic coin data records can be transmitted in any format. This implies that they can be communicated, that is transmitted, on any channel They do not need to be saved in a specific format or in a specific program.

In particular, a mobile telecommunication terminal, for example a smartphone, is regarded as a terminal. Alternatively or additionally, the terminal may also be a device such as a wearable, smart card, automat, tool, vending machine or container or vehicle. A terminal according to the invention is therefore either stationary or mobile.

The terminal is preferably configured to use the Internet and/or other public or private networks. For this purpose, the terminal uses a suitable connection technology, for example Bluetooth, Lora, NFC and/or WiFi and includes at least one corresponding interface. The terminal may also be configured to be connected to the Internet and/or other networks by means of access to a cellular network.

In one embodiment, when a plurality of electronic coin data records are present or have been received, the first and/or second terminal in the method shown are to process the received electronic coin data records according to their monetary value. It may thus be intended that electronic coin data records with a higher monetary value are processed before electronic coin data records with a lower monetary value. In one embodiment, the first and/or second terminal device may be configured, after receiving an electronic coin data record, to join it with the electronic coin data record already present in the second terminal device, depending on attached information, for example a currency or denomination, and to carry out a joining step accordingly. Furthermore, the second terminal may also be configured to automatically carry out a switch after receiving the electronic coin data record from the first terminal.

In one embodiment, additional information, in particular metadata, for example a currency, is transmitted from the first terminal to the second terminal during transmission. In one embodiment, this information may be included in the electronic coin data record.

In a preferred embodiment, the method comprises the further steps of: masking the transmitted electronic coin data record in the second terminal by applying the homomorphic one-way function to the transmitted electronic coin data record; and sending the masked transmitted electronic coin data record to the remote monitoring entity for checking the validity of the transmitted electronic coin data record by means of the remote monitoring entity. In this case, for example, the entire monetary amount was transferred to the second terminal as part of the electronic coin data record. Before a payee accepts this electronic coin data record, the payee checks the validity thereof if applicable. For this purpose, the second terminal generates the masked transmitted electronic coin data record, sends it to the monitoring entity and, in doing so, queries the validity of the electronic coin data record from the monitoring entity. The monitoring entity now checks whether the masked transmitted electronic coin data record is even present and whether it is still valid, i.e. has not already been used by another terminal, in order to avoid double spending.

In one embodiment, a proof is created in the second terminal. The proof includes information about the correspondence between the monetary amount of the transmitted electronic coin data record and the monetary amount of the electronic coin data record to be switched. The proof preferably only includes information about the correspondence, but not of the monetary amounts.

Preferably, the electronic coin data records of the first and/or second terminal are checked in the monitoring entity during registering. The check is carried out depending on the steps preceding the check, for example whether a step of switching, joining and/or splitting has taken place. Here, the monitoring entity may check, for example, the validity of the (masked) electronic coin data records which are transmitted and/or to be split and/or first and second. This makes it possible to determine whether the electronic coin records are being processed for the first time. If the (masked) electronic coin data records are not valid (i.e., in particular if they are not present in the monitoring entity), registering cannot be carried out successfully, for example because the terminal tries to output an electronic coin data record several times.

In a further preferred embodiment, after the switching step has been carried out in the terminal, the switch command prepared by the terminal is sent to the monitoring entity (as registration request). The switch command preferably includes the masked electronic coin data record received, the masked electronic coin data record to be switched and preferably includes additional information needed for checks in the monitoring entity. The additional information is used to prove to the “commanding” terminal that there is knowledge of the monetary amount and the concealment amount of the electronic coin data record received without communicating the values, preferably by means of zero knowledge proof. The checking entity checks the confirmability of the zero-knowledge proof, the validity of the masked electronic coin data record received and that the monetary amount of the electronic coin data record received is equivalent to the monetary amount of the electronic coin data record to be switched. In order to prove that only a new concealment amount has been added to the concealment amount of the received electronic coin data record, but the monetary amount has remained the same, the second terminal may preferably prove that the difference between the masked coin data record received and the masked coin data record to be switched has a special representation, namely that of a public key. This is done by generating a signature for the masked electronic coin data record to be switched with the added concealment amount. This generated signature of the masked electronic coin data record to be switched may then be checked in the monitoring entity, which is considered to be proof that the second terminal has knowledge of the added concealment amount. After successfully completing the checks that are relevant for the switch command, that is if the markings are appropriately complete, the (masked) electronic coin data record to be switched is preferably marked as valid. The masked electronic coin data record previously registered automatically becomes invalid, if applicable. Alternatively, the masked electronic coin data record previously registered is marked as invalid or deleted. The monitoring entity preferably communicates the result of the execution of the switch command, i.e. which of the masked electronic coin data records involved are valid after the switch command has been carried out, to the “commanding” terminal.

In a further preferred embodiment, after executing the splitting step, a split command prepared by the terminal is sent to the monitoring entity (as registration request) for registering. It includes the masked electronic coin data record to be split, the masked first electronic partial coin data record, the masked second electronic partial coin data record and preferably includes additional information needed for checks in the monitoring entity. The additional information serves as proof to the “commanding” terminal that there is knowledge of the monetary amount and the concealment amount of the electronic coin data record to be split up without communicating the values, preferably by means of a zero-knowledge proof. The checking entity checks the confirmability of the zero-knowledge proof, the validity of the masked electronic coin data record to be split and that the sum of the monetary amount of the first electronic coin data record and the monetary amount of the second electronic coin data record is equivalent to the monetary amount of the electronic coin data record to be split (amount neutrality). This is preferably done by the monitoring entity comparing the sum of the masked first electronic partial coin data record and the masked second electronic partial coin data record with the masked partial coin data record to be split.

In a further preferred embodiment, after the joining step has been carried out, a join command prepared by the terminal is sent to the monitoring entity for registering (as registration request). It includes the first masked electronic coin data record, the second masked electronic coin data record, and the masked partial coin data record to be joined and preferably includes additional information needed for checks in the monitoring entity. The additional information serves as proof to the “commanding” terminal that there is knowledge of the monetary amounts and the concealment amounts of the first and second electronic coin data records without communicating the values, preferably by means of a zero knowledge proof. The checking entity checks the confirmability of the zero-knowledge proof, the validity of the masked first electronic coin data record, the validity of the masked second electronic coin data record and that the sum of the monetary amount of the first electronic coin data record and the monetary amount of the second electronic coin data record is equivalent to the monetary amount of the electronic coin data record to be joined (amount neutrality). This is preferably done by the monitoring entity comparing the sum of the masked first electronic coin data record and the masked second electronic coin data record with the masked partial coin data record to be joined. After the checks relevant for the join command have been successfully completed, that is the markings are appropriately complete, the (masked) electronic coin data record to be joined is preferably marked as valid. Here, the (masked) first electronic coin data record and the (masked) second electronic coin data record automatically become invalid. Alternatively, the masked electronic coin data records previously registered are marked as invalid or deleted. The monitoring entity preferably communicates the result of the execution of the join command, i.e. which of the masked electronic coin data records involved are valid after the join command has been executed, to the “commanding” terminal.

In one embodiment, masking the transmitted electronic coin data record and checking the validity thereof are carried out before the transmitted electronic coin data record is registered in the monitoring entity. First, the second terminal sends a validity request for the masked received electronic coin data record and only uses the received electronic coin data record if it is valid. Subsequently, for example, the registration request may be sent or the received electronic coin data record (unmodified) may be passed on, in particular to another terminal or to another system participant such as a server entity of a commercial bank.

In a preferred embodiment, the monitoring entity is a remote entity. Thus, for example, it is intended to establish a communication connection to the monitoring entity for registering the electronic coin data record.

The monitoring entity is configured as a superordinate entity. The monitoring entity is therefore not necessarily arranged at the level or in the layer of the terminals (direct transaction layer). The monitoring entity is preferably provided for managing and checking masked electronic coin data records. It is arranged in an issuing layer, in which an issuer entity is also arranged, and/or in an independent monitoring layer. It is conceivable that the monitoring entity also manages and checks transactions between the first and second terminals.

The monitoring entity is preferably a decentrally controlled database, called Distributed Ledger Technology, DLT, in which the masked electronic coin data records are registered with corresponding processing of the masked electronic coin data record. In a preferred embodiment, a validity status of the (masked) electronic coin data record can be derived therefrom. The validity of the (masked) electronic coin data records is preferably noted in and by the checking entity. The registration of the processing or the processing steps may also relate to registering check results and intermediate check results relating to the validity of an electronic coin data record. If processing is final, this is indicated, for example, by appropriate markings or a derived overall marking. Final processing then decides whether an electronic coin data record is valid or invalid.

Moreover, this database is preferably a non-public database, but may also be implemented as a public database. This database makes it possible to check coin data records for their validity in a simple manner and to prevent “double-spending”, i.e. multiple spending, without the payment transaction itself being registered or logged. DLT describes a technology for networked computers that come to an agreement about the sequence of certain transactions and about these transactions updating data. It corresponds to a decentralized management system or a decentrally managed database.

In further embodiments, the database may also be configured as a public database.

Alternatively, the monitoring entity is a centrally managed database, for example in the form of a publicly accessible data storage or as a mixed form of central and decentral databases.

The initial electronic coin data records are preferably created exclusively by the issuer entity. Preferably, switched, split, or joined electronic coin data records, in particular electronic partial coin data records, may also be generated by a terminal. The creation and selection of a monetary amount preferably also comprises selecting a concealment amount with high entropy.

The issuer entity is a computing system which is preferably remote from the first and/or second terminal. The issuer entity is particularly preferably associated with a central bank. After creating the new electronic coin data record, the new electronic coin data record is masked in the issuer entity by applying the homomorphic one-way function to the new electronic coin data record in order to accordingly obtain a masked new electronic coin data record. Furthermore, additional information required for registering the creation of the masked new electronic coin data record in the remote monitoring entity is calculated in the issuer entity. This additional information is preferably proof that the (masked) new electronic coin data record originates from the issuer entity, for example by signing the masked new electronic coin data record. In one embodiment, it may be intended that the issuer entity signs a masked electronic coin data record with its signature when generating the electronic coin data record. The signature of the issuer entity is preferably stored in the monitoring entity. In one embodiment, it may be envisioned that the issuer entity also sends a range proof with the generated electronic coin data record in order to prove possession of the electronic coin data record.

The issuer entity may preferably deactivate an electronic coin data record that is in its possession (i.e., of which it knows the monetary amount and the concealment amount) by masking the electronic coin data record to be deactivated with the homomorphic one-way function and preparing a deactivate command or a deactivation request for the monitoring entity. In addition to the masked electronic coin data record to be deactivated, the proof that the deactivation step was initiated by the issuer entity, for example in the form of the signed masked electronic coin data record to be deactivated, is preferably also part of the deactivate command. As additional information, the deactivate command could include range proofs for the masked electronic coin data record to be deactivated. The deactivation of the masked electronic coin data record is then registered in the remote monitoring entity. The step of deactivating is triggered with the deactivate command.

In a further preferred embodiment, a deactivate command (or a deactivation request) is prepared in the issuer entity and is sent to the monitoring entity. The deactivate command includes the masked electronic coin data record to be deactivated and, preferably, additional information required for checks in the monitoring entity. The additional information serves to prove that the deactivate command was initiated by the issuer entity, preferably by means of the signed masked electronic coin data record to be deactivated. The checking entity checks the signature, the validity of the masked electronic coin data record to be deactivated and, optionally, the range proof of the masked electronic coin data record to be deactivated. After successfully completing the checks relevant for the deactivate command, that is, in particular, if the markings are appropriately complete, the (masked) electronic coin data record to be deactivated is preferably marked as invalid (or deleted). The monitoring entity preferably communicates the result of executing the deactivate command, i.e. that the (masked) electronic coin data record to be deactivated is invalid after the deactivate command has been executed, to the issuer entity.

The steps of creating and deactivating are preferably carried out in secure locations, in particular not in the terminals. In a preferred embodiment, the steps of creating and deactivating are only carried out or initiated by the issuer entity. These steps are preferably carried out in a secure location, for example in a hardware and software architecture that was developed for processing sensitive data material in insecure networks. Deactivating the corresponding masked electronic coin data record has the effect that the corresponding masked electronic coin data record is no longer available for further processing, in particular transactions, since it has been marked as invalid in and by the monitoring entity. However, in one embodiment it may be stipulated that the deactivated masked electronic coin data record remains archived at the issuer entity. The fact that the deactivated masked electronic coin data record is no longer valid may be identified, for example, using a flag or some other encoding or the deactivated masked electronic coin data record may be destroyed and/or deleted. Of course, the deactivated masked electronic coin data record may also be deleted.

The method according to the invention enables various processing operations for the electronic coin data records and the corresponding masked electronic coin data records. Each of the processing operations (in particular creating, deactivating, splitting, joining and switching) is registered in the monitoring entity. The processing operations may be appended there to the list of previous processing operations for the respective masked electronic coin data record in unchangeable form. The processing operations “create” and “deactivate”, which concern the existence of the monetary amount per se, that is the creation and deletion or even destruction of money, require additional approval, for example in the form of a signature, by the issuer entity in order to be registered in the monitoring entity. The other processing operations (splitting, joining, switching) do not require any authorization by the issuer entity or by the requester/command initiator (=payer, e.g. the first terminal).

Processing in the direct transaction layer only affects the ownership structure and/or the association of the coin data records with the terminals of the respective electronic coin data records. The respective processing results are registered in the monitoring entity. The database of valid masked coin data records is adapted accordingly, for example by adding and deleting masked coin data records. Preferably, however, it is implemented by means of corresponding list entries in a database which comprises a number of markings that must be set by the monitoring entity. One possible structure for a list entry includes, for example, column(s) for a predecessor coin data record, column(s) for a successor coin data record, a signature column for the issuer entity, and at least one marking column. A change in the status of the marking requires the approval of the monitoring entity and must then be saved unchangeably. A change is final if and only if the required markings have been validated by the monitoring entity, i.e. for example, if the status “0” has been changed to the status “1” after the corresponding check. If a check fails or takes too long, a change is made instead, for example, from the status “−” to the status “0”. Further status values are conceivable and/or the status values mentioned here are interchangeable. Preferably, the validity of the respective (masked) electronic coin data records is represented in a manner summarized from the status values of the markings in a column for each masked electronic coin data record involved in registering the processing.

In a further exemplary embodiment, at least two, preferably three, or even all of the aforementioned markings may also be replaced by a single marking which is set when all checks have been successfully completed. Furthermore, the two columns for predecessor data records and successor data records may each be combined into one in which all coin data records are listed together. In this way, more than two electronic coin data records could be managed per field entry, and thus, for example, a split into more than two coins could be implemented.

The checks by the checking entity for checking whether processing is final are already described above and are in particular:
Are the masked electronic coin data records of the predecessor column(s) valid?
Does a check obtain the correct check value?
Are the range proofs for the masked electronic coin data records successful?
Is the signature of the masked electronic coin data record a valid signature of the issuer entity?

It is also preferred that a masked electronic coin data record is invalid when one of the following checks is triggered, that is when:
(1) the masked electronic coin data record is not registered in the monitoring entity;
(2) the last processing of the masked electronic coin data record indicates that there are predecessor coin data records for it, but this last processing is not final; or
(3) the last processing of the masked electronic coin data record indicates that there are successor coin data records for it and this last processing is final.
(4) the masked electronic coin record is not the successor to a valid masked electronic record unless it is signed by the issuer entity.

The steps of switching, splitting or joining (registering modifications) and creating and deactivating (initial registration and final deregistration) listed here are each triggered in the monitoring entity by corresponding requests (or commands), for example a corresponding create, switch, split, join or deactivate command.

In one aspect of the invention, a payment system for exchanging monetary amounts is provided with an accounting layer including a database (preferably a decentrally controlled database, Distributed Ledger Technology, DLT), in which masked electronic coin data records are stored; and a direct transaction layer including at least two terminals in which the method described above can be executed; and/or an issuer entity for initially generating or creating an electronic coin data record. Here, the issuer entity may prove that the masked generated electronic coin data record was generated by it and the issuer entity may preferably identify itself by signing and the monitoring entity may check the signature of the issuer entity. In one embodiment, it may be envisioned that the issuer entity also sends a range proof with the generated electronic coin data record in order to prove possession of the electronic coin data record.

In a preferred embodiment, the payment system comprises an issuer entity for generating an electronic coin data record. Here, the issuer entity may prove that the masked generated electronic coin data record was generated by it and the issuer entity may preferably identify itself by signing and the monitoring entity may check the signature of the issuer entity. In one embodiment, it may be envisioned that the issuer entity also sends a range proof with the generated electronic coin data record in order to prove possession of the electronic coin data record.

The payment system is preferably configured to carry out the above-mentioned method and/or at least one of the embodiment variants.

Another aspect of the invention relates to a currency system comprising an issuer entity, a monitoring entity, a first terminal, and a second terminal, the issuer entity being configured to create an electronic coin data record. The masked electronic coin data is formed such that it has been verifiably created by the issuer entity. The monitoring entity is configured to carry out one of the above-mentioned methods, i.e., in particular, the processing of registration requests. Preferably, the terminals, i.e. at least the first and second terminals, are suitable for carrying out one of the above-mentioned methods for transmitting coin data records.

In a preferred embodiment of the currency system, only the issuer entity is authorized to initially create an electronic coin data record. Processing, for example the step of joining, splitting and/or switching, can be and is preferably carried out by a terminal. Preferably, the processing step of deactivating may only be carried out by the issuer entity. Thus, only the issuer entity would be authorized to invalidate the electronic coin data record and/or the masked electronic coin data record.

The checking entity and the issuer entity are each preferably arranged in a server entity or are available as a computer program product on a server and/or a computer.

An electronic coin data record may be provided in a large number of different forms and may thus be exchanged via various communication channels, also referred to below as interfaces. This creates a very flexible exchange of electronic coin data records.

The currency system may include further coin owner entities, in particular server entities or computer entities. Like the terminals, the coin owner entities may transmit electronic coin data records, in particular to one another or from or to terminals, and send registration requests for masked modified electronic coin data records to the monitoring entity. Further coin owner entities may be associated with commercial banks, online shops or service providers, for example.

What is proposed here is a solution that issues digital money in the form of electronic coin data records, which is similar to the use of conventional (analog) bank notes and/or coins. The digital money is represented by electronic coin data records. As with (analog) bank notes, these electronic coin data records can also be used for all forms of payments, including peer-to-peer payments and/or POS payments. The knowledge of all components (in particular the monetary amount and the concealment amount) of a valid electronic coin data record is equivalent to the possession (ownership) of the digital money. It is therefore advisable to treat these valid electronic coin data records confidentially, for example to store them in a security element/safe module of a terminal and to process them therein. In order to decide on the authenticity of an electronic coin data record and to prevent double spending, masked electronic coin data records are maintained in the monitoring entity as a corresponding unique public representation of the electronic coin data record. The knowledge or the possession of a masked electronic coin data record does not represent the possession of money. Rather, this is equivalent to checking the authenticity of the analog means of payment.

The monitoring entity stores the valid masked electronic coin data records. A recipient of an electronic coin data record will therefore first generate a masked received electronic coin data record and will have the validity of the masked electronic coin data record confirmed by the monitoring entity. A great advantage of this solution according to the invention is that the digital money is distributed to terminals, retailers, banks and other users of the system, but no digital money or other metadata is stored in the monitoring entity—that is, a shared entity. The monitoring entity may preferably also store a validity status of the masked electronic coin data records and/or contain markings regarding executed and planned processing of the masked electronic coin data record. A status of the respective masked electronic coin data record which indicates whether the corresponding (unmasked) electronic coin data record is valid, i.e. ready for payment, can be derived from the markings relating to the processing.

The proposed solution may be integrated into existing payment systems and infrastructures. In particular, there may be a combination of analog payment processes with bank notes and coins and digital payment processes in accordance with the present solution. A payment process may take place with bank notes and/or coins, but the change or drawback is available as an electronic coin data record. For example, ATMs with a corresponding configuration, in particular with a suitable communication interface, and/or mobile terminals may be provided for the transaction. An exchange of electronic coin data records for bank notes or coins is also conceivable.

### BRIEF DESCRIPTION OF THE FIGURES

The invention and further embodiments and advantages of the invention are explained in more detail below with reference to figures, said figures merely describing exemplary embodiments of the invention. The same components in the figures are provided with the same reference symbols. The figures are not to be regarded as true to scale; individual elements of the figures may be shown exaggeratedly large or exaggeratedly simplified.

In the figures:

FIG. 1 shows an embodiment of a payment system according to the invention;

FIG. 2 shows an embodiment of a monitoring entity;

FIG. 3 shows an embodiment of a payment system according to the invention for splitting and switching electronic coin data records;

FIG. 4 shows an embodiment of a payment system according to the invention for joining electronic coin data records;

FIG. 5 shows an exemplary embodiment of a method flow diagram of a method according to the invention and corresponding processing steps of a coin data record;

FIG. 6 shows an embodiment of a method flow diagram of a method according to the invention and corresponding processing steps of a coin data record;

FIG. 7 shows a further exemplary embodiment of a method flow diagram of a method according to the invention.

### DESCRIPTION OF FIGURES

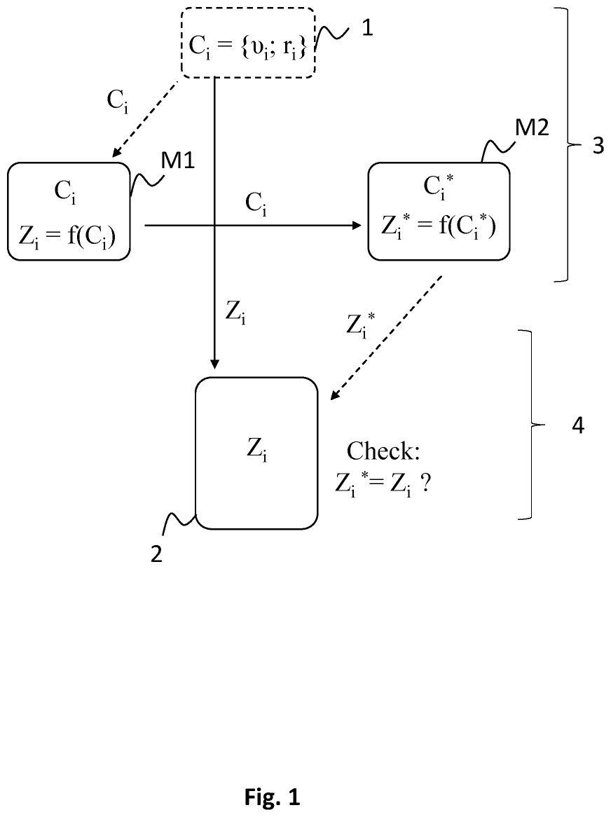

FIG. 1 shows an embodiment of a payment system including terminals M1 and M2 according to the invention.

Here, an electronic coin data record Cᵢ is generated in an issuer entity 1, for example a central bank. For the electronic coin data record Cᵢ, which includes a concealment amount, a masked electronic coin data record Zᵢ is generated and registered in a database as a monitoring entity, which may be referred to as a “concealed electronic data record ledger” here. In the context of this invention, a ledger is understood to be a list, a directory, preferably a database structure. The electronic coin data record Cᵢ is output to a first terminal M1.

For example, a true random number was generated for this purpose as the concealment amount rᵢ. This concealment amount rᵢ is linked to a monetary amount and then forms an i-th electronic coin data record according to the invention:

Cᵢ={νᵢ; rᵢ} (1)

A valid electronic coin data record can be used for payment. The owner of the two values νᵢ and rᵢ is therefore already in possession of the digital money since the owner can use it for payment. However, the digital money is defined in the system by a pair consisting of a valid electronic coin data record and a corresponding masked electronic coin data record Zᵢ. The masked electronic coin data record Zᵢ is obtained by applying a homomorphic one-way function f(Cᵢ) according to Equation (2):

Zᵢ=ƒ(Cᵢ) (2)

This function f(Cᵢ) is public, i.e. every system participant may call and use this function. This function f(Cᵢ) is defined according to Equation (3):

Zᵢ=νᵢ·H+rᵢ·G (3)

where H and G are generator points of a group G, in which the discrete logarithm problem is hard, with the generators G and H, for which the discrete logarithm of the respective other base is unknown. For example, G and H are generator points of elliptical curve cryptography, ECC—that is, private keys of the ECC. These generator points G and H must be chosen in such a way that the relationship between G and H is not publicly known, so that with:

G=n·H (4)

the link n must be practically impossible to find in order to prevent the monetary amount νᵢ from being manipulated while a valid Zᵢ can still be calculated. Equation (3) is a “Pederson commitment for ECC” ensuring that the monetary amount νᵢ can be passed, i.e. “committed”, to a monitoring entity 2 without revealing it to the monitoring entity 2. Therefore, only the masked coin data record Zᵢ is sent (revealed) to the public and remote monitoring entity 2.

Even if encryption based on elliptical curves is or is described in the present example, another cryptographic method based on a discrete logarithmic method would also be conceivable.

Due to the entropy of the concealment amount rᵢ, Equation (3) allows for a cryptographically strong Zᵢ to be obtained even with a small range of values for monetary amounts νᵢ. This means that a simple brute force attack by simply estimating monetary amounts νᵢ is practically impossible.

Equation (3) is a one-way function, which means that the computation of Zᵢ from Cᵢ is easy because an efficient algorithm exists, whereas the computation of Cᵢ from Zᵢ is very difficult because there is no algorithm that can be solved in polynomial time.

In addition, Equation (3) is homomorphic for addition and subtraction, i.e. the following applies:

Zᵢ+Zⱼ=(νᵢ·H+rᵢ·G)+(νⱼ·H+rⱼ·G)=(νᵢ+νⱼ)·H+(rᵢ+rⱼ)·G (5)

Thus, addition operations and subtraction operations can be carried out both in the direct transaction layer 3 and also in parallel in the accounting layer 4 without the accounting layer 4 having knowledge of the electronic coin data records Cᵢ. The homomorphic property of Equation (3) allows for accounting of valid and invalid electronic coin data records Cᵢ on the sole basis of the masked coin data records Zᵢ and ensuring that no new monetary amount νⱼ has been created.

Due to this homomorphic property, the coin data record Cᵢ can be split according to Equation (1) into:

Cᵢ=Cⱼ+Cₖ={νⱼ;rⱼ}+{νₖ; rₖ} (6)

where:

νᵢ=νⱼ+νₖ (7)

rᵢ=rⱼ+rₖ (8)

The following applies to the corresponding masked coin data records:

Zᵢ=Zⱼ+Zₖ (9)

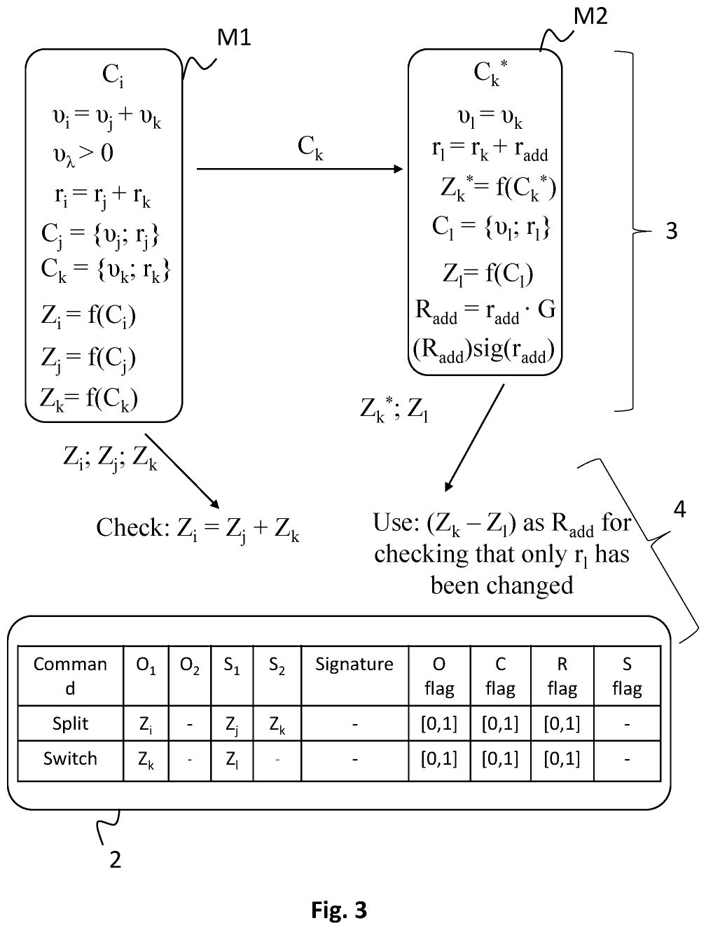

With Equation (9), for example, a “split” processing or a “split” processing step of a coin data record according to FIG. 3 may be checked in a simple manner without the monitoring entity 2 having knowledge of Cᵢ, Cⱼ, Cₖ. Specifically, the condition of Equation (9) is checked to validate split coin records Cⱼ and Cₖ and invalidate coin record Cᵢ. Such a split of an electronic coin data record Cᵢ is shown in FIG. 3.

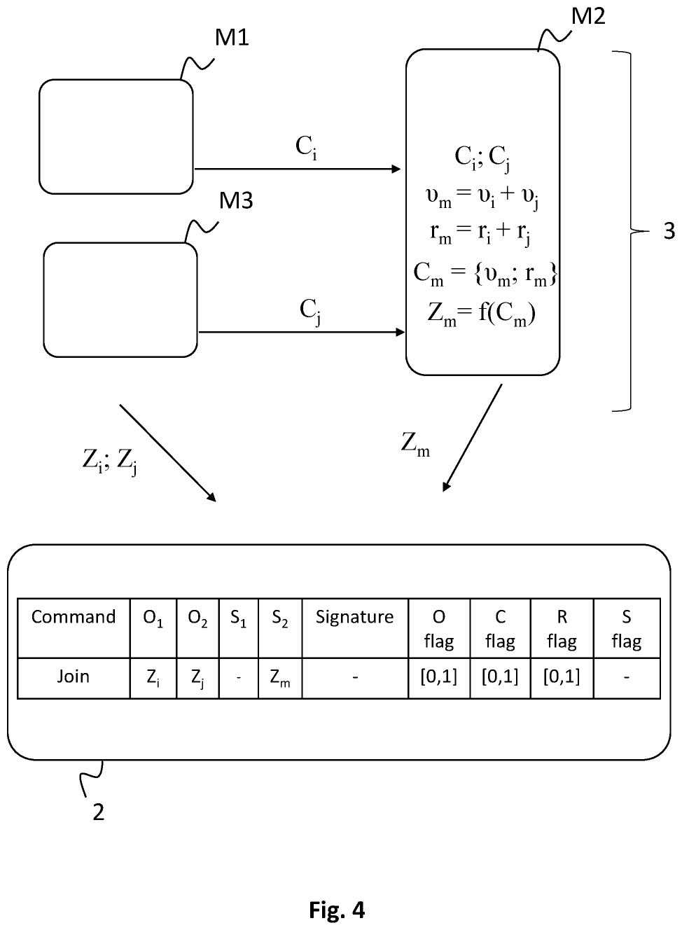

In the same way, electronic coin data records can also be put together (joined), see FIG. 4 and the explanations therefor.

In addition, it is necessary to check whether (not allowed) negative monetary amounts are registered. An owner of an electronic coin data record Cᵢ must be able to prove to the monitoring entity 2 that all monetary amounts νᵢ in a processing operation are within a value range of [0, . . . , n] without informing the monitoring entity 2 about the monetary amounts νᵢ. These proofs of range are also called “range proofs”. Ring signatures are preferably used as range proofs. For the present exemplary embodiment, both the monetary value and the concealment amount of an electronic coin data record are resolved in bit representation, i.e. νᵢ=Σaⱼ*2^{j} for 0≤j≤n and aⱼ “element” {0; 1} and rᵢ=Σbⱼ*2^{j} for 0≤j≤n and bⱼ “element” {0; 1}. A ring signature with Cᵢⱼ=aⱼ·H+bⱼ·G and Cᵢⱼ−aⱼ·H is preferably carried out for each bit, wherein, in one embodiment, it is possible to carry out a ring signature only for certain bits.

What is not shown in FIG. 1 and will only be explained later is that new electronic coin data records Cᵢ are preferably not output directly to terminals, but rather initially to commercial bank, for example.

In FIG. 1, an electronic coin data record Cᵢ is generated by the issuer entity 1 and a masked electronic coin data record Zᵢ is calculated by the issuer entity 1 using Equation (3) and registered in the monitoring entity 2. The first terminal M1 subsequently transmits the electronic coin data record Cᵢ to a second terminal M2. Before that, the terminal may optionally carry out one of the processing steps (switching, joining, splitting). The transmission takes place wirelessly via WLAN, NFC or Bluetooth, for example. The transmission may be additionally secured by cryptographic encryption methods, for example by negotiating a session key or using a PKI infrastructure.

The transmitted electronic coin data record Cᵢ is received as Cᵢ* in the second terminal M2. When the electronic coin data record Cᵢ* is received, the second terminal M2 is in possession of the digital money represented by the electronic coin data record Cᵢ*. If both terminals trust each other, no further steps are necessary to end the process. However, the terminal M2 does not know whether the electronic coin data record Cᵢ* is actually valid. In addition, the terminal M1 could also transmit the electronic coin data record Cᵢ to a third terminal (not shown). In order to prevent this, further preferred steps are provided in the method.

In order to check the validity of the received electronic coin data record Cᵢ*, the masked transmitted electronic coin data record Zᵢ* is calculated in the second terminal M2 with the—public—one-way function from Equation (3). The masked transmitted electronic coin data record Zᵢ*is then transmitted to the monitoring entity 2 and searched there. If there is a match with a registered and valid masked electronic coin data record, the validity of the received coin data record Cᵢ* is indicated to the second terminal M2 and it is determined that the received electronic coin data record Cᵢ* is equal to the registered electronic coin data record Cᵢ. With the check for validity, it may be determined, in one embodiment, that the received electronic coin data record Cᵢ* is still valid, i.e. that it has not already been used by another processing step or in another transaction and/or was subject to another change.

Preferably, the electronic coin data record obtained is then switched by the second terminal.

It is essential to the method according to the invention that the sole knowledge of a masked electronic coin data record Zᵢ does not entitle the holder to spend the digital money. The sole knowledge of the electronic coin data record Cᵢ, however, authorizes payment, i.e. to successfully carry out a transaction, in particular if the coin data record Cᵢ is valid. There is a 1-to-1 relationship between the electronic coin data records Cᵢ and the corresponding masked electronic coin data records Zᵢ. The masked electronic coin data records Zᵢ are registered in the monitoring entity 2, for example a public decentralized database. This registration makes it possible to check the validity of the data record, for example whether new monetary amounts have been created (illegally).

A main distinguishing feature compared to conventional solutions is that the masked electronic coin data records Zᵢ are stored in a monitoring layer 4 and all processing operations on the electronic coin data record Zᵢ are registered there, whereas the actual transmission of the digital money takes place in a (secret, i.e. one not known to the public) direct transaction layer 3.

In order to prevent multiple spending or to ensure more flexible transmission, the electronic coin data records can now be processed in the method according to the invention. The following table 1 lists the individual operations, with the specified command also executing a corresponding processing step:

TABLE 1
Number of operations to be carried out per processing of a coin
data record in the terminal or issuer entity; further operations
not listed here are required; instead of the implementation listed,
other implementations implying other operations are conceivable

| Command or | Create | Create random | Create | Create range |
|---|---|---|---|---|
| step | signature | number | mask | proof |
| Create | 1 | 1 | 1 | 0 or 1 |
| Deactivate | 1 | 0 | 1 | 0 or 1 |
| Split | 0 | 1 | 3 | 0 or 1 |
| Join | 0 | 0 | 3 | 1 |
| Switch | 0 | 1 | 2 | 1 |

Table 1 above shows that, for each coin data record and each of the processing operations “create”, “deactivate”, “split”, “join” and “switch”, different operations “create signature”; “create random number”; “create mask”; “range proof” may be provided, each of the processing operations being registered in the monitoring entity 2. It may be appended there in unchangeable form to a list of previous processing operations for masked electronic coin data records Zᵢ. The processing operations of “create” and “deactivate” on an electronic coin data record are only carried out in secure locations and/or only by selected entities, for example the issuer entity 1, while the operations of all other processing operations can be carried out on terminals M1 to M3.

The number of operations for the individual processing is marked in table 1 with “0”, “1” or “2”. The number “0” indicates that the terminal or issuer entity 1 does not have to carry out this operation for this processing of the electronic coin data record. The number “1” indicates that the terminal or issuer entity 1 must be able to carry out this operation once for this processing of the electronic coin data record. The number “2” indicates that the terminal or issuer entity 1 must be able to carry out this operation twice for this processing of the electronic coin data record.

In principle, it may also be planned, in one embodiment, that a range proof is also carried out by the issuer entity 1 during creation and/or deactivation.

The operations required for the monitoring entity 2 for the individual processing operations are listed in the Table 2 below:

TABLE 2
Number of operations to be carried out per processing of a coin data
record in the monitoring entity; further operations not listed here
are required; instead of the implementation listed,
other implementations implying other operations are conceivable

| | Checking | Checking the | | Checking homo- |
|---|---|---|---|---|
| | the | validity of the | | morphic properties |
| | signature | masked | Checking | of the masked |
| Command | of | electronic | range | electronic coin data |
| or step | the issuer | data record | proof | records, i.e. adding |
| Create | 1 | 0 | 0 or 1 | 0 |
| Deactivate | 1 | 1 | 0 or 1 | 0 |
| Split | 0 | 1 | 2 or more | 1 |
| Join | 0 | 2 or more | 1 | 1 |
| Switch | 0 | 1 | 1 | 0 |

All operations of Table 2 can be carried out in the monitoring entity 2, which, as a trusted entity, for example as a decentralized server, in particular a distributed trusted server, ensures sufficient integrity of the electronic coin data records.

Table 3 shows the components to be preferably installed for the system participants in the payment system of FIG. 1:

TABLE 3
Preferred units in the system components

| | Issuer | | Monitoring |
|---|---|---|---|
| Command or step | entity | Terminal | entity |
| Random number generator | Yes | — | — |
| (high security) | | | |
| Random number generator | — | Yes | — |
| (deterministic) | | | |
| PKI for signing | Yes | — | — |
| PKI for checking signature | — | (Yes) | Yes |
| Read access on DLT | Yes | Yes | Yes |
| Write access on DLT | Yes | Yes | Yes |
| Deactivating the electronic coin | Yes | Yes | — |
| data record | | | |
| Transport encryption | Yes | Yes | — |
| Safe storage | (Yes) | Yes | —/Yes |
| Masking unit | Yes | Yes | — |
| Range proof | — | Yes | — |
| Checking range proof | — | — | Yes |
| DLT software | — | — | Yes |

Table 3 shows an overview of the components to be preferably used in each system participant, i.e. the issuer entity 1, a terminal M1 and the monitoring entity 2. The terminal M1 may be configured as a wallet for electronic coin data records, i.e. as an electronic purse, i.e. a data storage for the terminal in which a large number of coin data records can be stored, and may be implemented, for example, in the form of an application on a smartphone or IT system of a retailer, a commercial bank or another market participant, and send or receive an electronic coin data record. Thus, the components in the terminal as shown in Table 3 are implemented as software. It is assumed that the monitoring entity 2 is based on a DLT and is operated by a number of trusted market participants.

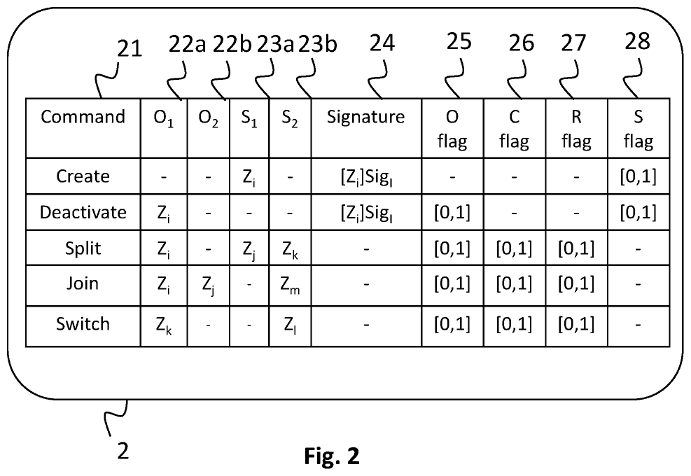

FIG. 2 shows an exemplary embodiment of a monitoring entity 2 from FIG. 1. In FIG. 2, an exemplary database is shown in the form of a table in which the masked electronic coin data records Zᵢ and possibly—as shown here—processing thereof are registered. In the simplest embodiment of the database, on the other hand, only the currently valid masked coin data records Zᵢ would be stored. The monitoring entity 2 is preferably arranged remote from the terminals M1 to M3 locally and is accommodated, for example, in a server architecture.

Each processing operation for a processing (creating, deactivating, splitting, joining and switching) is registered in the monitoring entity 2 and appended there in unchangeable form to a list of previous processing operations for masked electronic coin data records Zᵢ. The individual operations or their check results, that is to say the intermediate results of processing, are recorded in the monitoring entity 2.

The processing of “creating” and “deactivating”, which concerns the existence of the monetary amount νᵢ per se, that is, the creation and destruction of money, require additional approval by the issuer entity 1 in order to be registered (and logged) in the monitoring entity 2. The other processing operations (splitting, joining, switching) do not require any authorization by the issuer entity 1 or by the command initiator (=payer, for example the first terminal M1).

The registration of the respective processing in the monitoring entity 2 is realized, for example, by means of corresponding list entries in the database according to FIG. 2. Each list entry has further markings 25 to 28 documenting the intermediate results of the respective processing that must be carried out by the monitoring entity 2. The markings 25 to 28 are preferably used as an aid and are discarded by the checking entity after the commands have been completed. What remains then are markings (not shown) regarding the validity of the (masked) electronic coin data records from columns 22a, 22b, 23a and/or 23b. When a processing command is received, the markings are, for example, in the “−” status and are set to the “1” status after all checks have been successfully completed and to the “0” status if at least one check has failed. A possible structure for a list entry of a coin data record includes, for example, two columns 22a, 22b for a predecessor coin data record (O1, O2), two columns 23a, 23b for a successor coin data record (S1, S2), a signature column 24 for the issuer entity(entities) 1, and four marking columns 25 to 28. Each of the entries in columns 25 to 28 has three alternative status “−”, “1” or “0”. Column 25 (O flag) indicates whether a validity check with regard to an electronic coin data record in column 23a/b was successful. The status “1” means that a validity check showed that the electronic coin data record in column 23a/b is valid and the status “0” indicates that a validity check showed that the electronic coin data record in column 23a/b is invalid and status “−” shows indicating a validity check has not yet been completed. Column 26 (C flag) indicates whether the one calculation to check the amount neutrality of the masked electronic coin data records was successful. The status “1” means that a calculation was successful and the status “0” indicates that the calculation was not successful and the status “−” indicates that the computation has not yet been completed.

For example, the calculation to be performed in column 26 is:

(Z_{O1}+Z_{O2})−(Z_{S1}+Z_{S2})==0 (10)

Column 27 (R flag) indicates whether a check of the range proof(s) was successful, where status “1” means that a validity check showed that the range proof(s) are confirmable and status “0” indicates that a validity check showed that the range proof(s) could not be reproduced and status “−” indicates that a validity check has not yet been completed. Column 28 (S flag) shows the successful verification of the signature. Status “1” means that a validity check showed that the signature could be identified as that of the issuer entity and status “0” indicates that a validity check showed that the signature could not be identified as that of the issuer entity and status “−” indicates that this validity check has not yet been completed.

A change in the status of one of the markings (also referred to as “flags”) requires approval by the monitoring entity 2 and must then be stored in the monitoring entity 2 in an unchangeable manner. Processing is final if and only if the required markings 25 to 28 have been validated by the monitoring entity 2, i.e. have changed from state “0” to state “1” or state “1” after the corresponding check.

In order to determine whether a masked electronic coin data record Z is valid, the monitoring entity 2 searches—in the present variant—for the last change that affects the masked electronic coin data record. It is essential that the masked electronic coin data record Z is valid if and only if the masked electronic coin data record Z is listed for its last processing in one of the successor columns 23a, 23b and this last processing has the corresponding final marking 25 to 28. It is also essential that the masked electronic coin data record Z is valid if and only if the masked electronic coin data record Z is listed for its last processing in one of the predecessor columns 22a, 22b and this last processing failed, i.e. at least one of the correspondingly requested states of the markings 25 to 28 is set to “0”.

It is also essential that the masked electronic coin data record Z is not valid for all other cases, for example if the masked electronic coin data record Z is not found in the monitoring entity 2; or if the last processing of the masked electronic coin data record Z is listed in one of the successor columns 23a, 23b, but this last processing never became final; or if the last processing of the masked electronic coin data record Z is in one of the predecessor columns 22a, 22b and this last processing is final.

The checks by the monitoring entity 2 to check whether processing is final are shown in columns 25 to 28: The status in column 25 indicates whether the masked electronic coin data record(s) are valid according to predecessor columns 22a, 22b. The status in column 26 indicates whether the calculation for amount neutrality, for example according to Equation (10), is correct. The status in column 27 indicates whether the range proof for the masked electronic coin data records Z could be checked successfully. The status in column 28 indicates whether the signature in column 24 of the masked electronic coin data record Z is a valid signature of the issuer entity 1.

The status “0” in one of columns 25 to 28 indicates that the check was not successful. The status “1” in one of columns 25 to 28 indicates that the check was successful. The status “−” in one of columns 25 to 28 indicates that no check has been carried out. The status may also have a different value, as long as it is possible to clearly differentiate between success/failure of a check and it is clear whether a certain check was carried out.

As an example, five different processing operations are defined, which are explained in detail here. Reference is made to the corresponding list entry in FIG. 2.

One processing operation is, for example, “creating” an electronic coin data record Cᵢ. The creation in the direct transaction layer 3 by the issuer entity 1 includes choosing a monetary amount νᵢ and creating a concealment amount rᵢ, as has already been described with Equation (1). As shown in FIG. 2, no entries/markings are required in columns 22a, 22b, 23b and 25 to 27 during the “create” processing. The masked electronic coin data record Z is registered in the successor column 23a. This registration is preferably carried out before the transmission to a terminal M1 to M3, in particular or already during creation by the issuer entity 1, wherein Equation (3) must be executed in both cases. The masked electronic coin data record Zᵢ is signed by the issuer entity 1 when it is created; this signature is entered in column 24 to ensure that the electronic coin data record Cᵢ was actually created by an issuer entity 1, although other methods may also be used for this purpose. If the signature of a received Zᵢ matches the signature in column 24, the marking is set in column 28 (from “0” to “1”). The markings according to columns 25 to 27 do not require a status change and can be ignored. The range proof is not required since the monitoring entity 2 trusts in the issuer entity 1 not issuing any negative monetary amounts. In an alternative embodiment, however, it may be sent by the issuer entity 1 in the create command and checked by the monitoring entity 2.

A processing operation is, for example, “deactivating”. The deactivation, that is to say the destruction of money, has the effect that the masked electronic coin data record Zᵢ becomes invalid after the issuer entity 1 has successfully executed the deactivate command. The (masked) electronic coin data record to be deactivated can therefore no longer be processed further in the accounting layer 4. In order to avoid confusion, the corresponding (unmasked) electronic coin data records Cᵢ should also be deactivated in the direct transaction layer 3. When “deactivating”, the predecessor column 22a is written with the electronic coin data record Zᵢ, but no subsequent column 23a, 23b is used. When deactivating, the masked electronic coin data record Zᵢ must be checked to see whether the signature matches the signature according to column 24 in order to ensure that the electronic coin data record Cᵢ was actually created by an issuer entity 1, although other means may be used for this check. If the signed Zᵢ, which is sent with the deactivate command, can be confirmed as signed by the issuer entity 1, the marking 28 is set (from “0” to “1”). The markings according to columns 26 to 27 do not require a status change and can be ignored. The markings according to columns 25 and 28 are set after appropriate checking.

A processing operation is, for example, “splitting”. Splitting, that is dividing an electronic coin data record Zᵢ into two electronic partial coin data records Zⱼ and Zₖ, is initially carried out in the direct transaction layer 3, as shown in FIG. 3, wherein the monetary amounts νⱼ and the concealment amount rⱼ are generated. νₖ and rₖ result from Equations (7) and (8). In the monitoring entity 2, the markings 25 to 27 are set, the previous column 22a is written with the electronic coin data record Zᵢ, the next column 23a is written with Zⱼ and the next column 23b is written with Zₖ. The status change required according to columns 25 to 27 takes place after the corresponding check by the monitoring entity 2 and document the respective check result. The marking according to column 28 is ignored.

One processing operation is, for example, “joining”. Joining, i.e. merging two electronic coin data records Zᵢ and Zⱼ to form one electronic coin data record Zₘ, is initially carried out in the direct transaction layer 3, as shown in FIG. 4, wherein the monetary amount νₘ and the concealment amount rₘ are calculated. In the monitoring entity 2, the markings 25 to 27 are set, the previous column 22a is written with the electronic coin data record Zᵢ, the previous column 22b is written with Zⱼ and the next column 23b is written with Zₘ. The markings in columns 25 to 27 require status changes and monitoring entity 2 carries out the corresponding checks. A range proof must be provided to show that no new money has been created. The marking according to column 28 is ignored.

One processing operation is, for example, “switching”. Switching is necessary if an electronic coin data record has been transmitted to another terminal and a renewed issue by the transmitting terminal (here M1) is to be excluded. When switching, also called “switch”, the electronic coin data record Cₖ received from the first terminal M1 is exchanged for a new electronic coin data record Cₗ with the same monetary amount. The new electronic coin data record Cₗ is generated by the second terminal M2. This switch is necessary in order to invalidate (make invalid) the electronic coin data record Cₖ received from the first terminal M1, thereby preventing the same electronic coin data record Cₖ from being output again. This is because, as long as the electronic coin data record Cₖ has not been switched, the first terminal M1 can pass this electronic coin data record Cₖ to a third terminal M3 since the first terminal M1 has knowledge of the electronic coin data record Cₖ. Switching is carried out, for example, by adding a new concealment amount r_{add} to the concealment amount rₖ of the obtained electronic coin data record Cₖ, whereby a concealment amount rᵢ is obtained which only the second terminal M2 knows. This may also carried out in the monitoring entity 2. To prove that only a new concealment amount r_{add} was added to the concealment amount rₖ of the masked received electronic coin data record Zₖ, but the monetary amount remained the same, so that Equation (11):

νₖ=νₗ (11)

is valid, the second terminal M2 must be able to prove that Zₗ−Zₖ can be represented as a scalar multiple of G, i.e. as r_{add}*G. This means that only a concealment amount r_{add} was generated and the monetary amount of Zₗ is equal to the monetary amount of Zₖ, i.e. Zₗ=Zₖ+r_{add}*G. This is done by generating a signature with the public key Zₗ−Zₖ=r_{add}*G.

In FIG. 3, an embodiment of a payment system according to the invention for splitting and switching of electronic coin data records is shown. In FIG. 3, the first terminal M1 has received the coin data record Cᵢ and would now like to carry out a payment transaction not with the entire monetary amount νᵢ, but only with a part vₖ thereof. For this purpose, the coin data record Cᵢ is split. To do this, the monetary amount is split first:

νᵢ=νⱼ+νₖ (12)

Here, each of the received amounts νⱼ, νₖ must be greater than 0 because negative monetary amounts are not permitted. In addition, new concealment amounts are derived:

rᵢ=rⱼ+rₖ (13)

The masked coin data records Zⱼ and Zₖ are then obtained from the coin data records Cⱼ and Cₖ in accordance with Equation (3) and are registered in the monitoring entity 2. For the split, the predecessor column 22a is described with the coin data record Zᵢ, the successor column 23a with Zⱼ and the successor column 23b with Zₖ. The markings in columns 25 to 27 require a status change and the monitoring entity 2 carries out the corresponding checks. The marking according to column 28 is ignored.

Then a coin data record, here Cₖ, is transmitted from the first terminal M1 to the second terminal M2. In order to prevent double spending, a switch operation is useful in order to exchange the electronic coin data record Cₖ received from the first terminal M1 for a new electronic coin data record Cₗ with the same monetary amount. The new electronic coin data record Cₗ is generated by the second terminal M2. The monetary amount of the coin data record Cₗ is adopted and not changed, see Equation (11). Then, according to Equation (14), a new concealment amount r_{add} is added to the concealment amount rₖ of the received electronic coin record Cₖ,

rₗ=rₖ+r_{add} (14)

whereby a concealment amount rₗ which only the second terminal M2 knows is obtained. In order to prove that only a new concealment amount r_{add} was added to the concealment amount rₖ of the received electronic coin data record Zₖ, but the monetary amount remained the same (νₖ=νₗ), the second terminal M2 must be able to prove that Zₗ−Zₖ can be represented as a multiple of G. This is done using the public signature R_{add} according to Equation (15):

R_{add}=r_{add}·G

=Zₗ−Zₖ=(νₗ−νₖ)*H+(rₖ+r_{add}−rₖ)*G (15)

where G is the generator point of the ECC. Then the coin data record Cₗ to be switched is masked by means of Equation (3) in order to obtain the masked coin data record Zₗ. The private signature r_{add} may then be used in the monitoring entity 2 in order, for example, to sign the masked electronic coin data record Zₗ to be switched, which is valid as proof that the second terminal M2 has only added a concealment amount r_{add} to the masked electronic coin data record and no additional monetary value, i.e., vₗ=vₖ.

The proof is as follows:

Zₖ=νₖ·H+rₖ·G

Zₗ=νₗ·H+rₗ·G=νₖ·H+(rₖ+r_{add})·G

Zₗ−Zₖ=(rₖ+r_{add}−rₖ)·G

=r_{add}·G (16)

FIG. 4 shows an exemplary embodiment of a payment system according to the invention for joining electronic coin data records. The two-coin data records Cᵢ and Cⱼ are received in the second terminal M2. Similar to the split according to FIG. 3, a new coin data record Zₘ is now obtained by adding both the monetary amounts and the concealment amount of the two-coin data records Cᵢ and Cⱼ. Then, the received coin data record Cₘ to be joined is masked and the masked coin data record Zₘ is registered in the monitoring entity.

In FIGS. 3 and 4, the variant of a database of the monitoring entity 2 which contains a list of processing operations of the masked coin data records is shown again. Other variants of a database, for example masked coin data records with status or only valid masked coin data records, may also be used—as already mentioned with respect to FIG. 2.

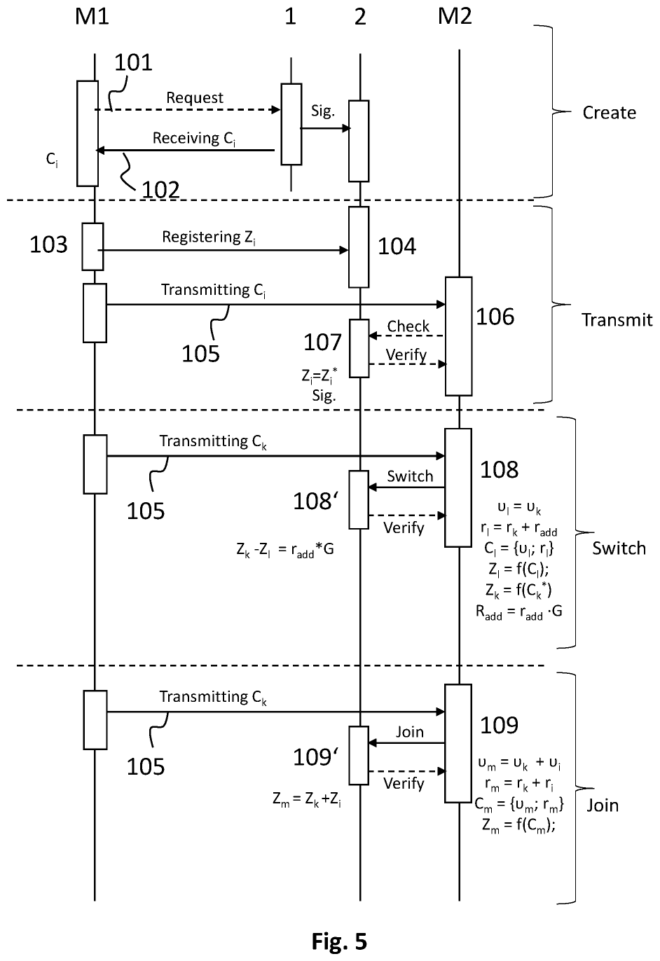

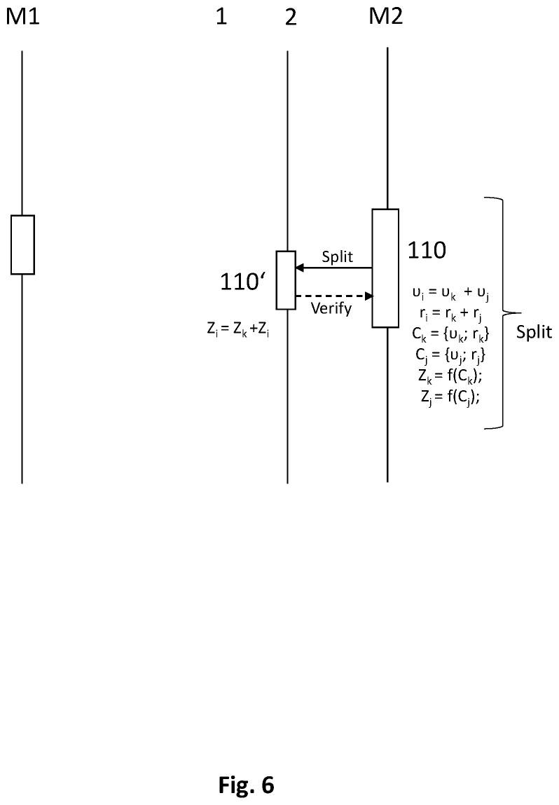

FIGS. 5 to 7 are each exemplary embodiments of a method flow chart of a method 100 according to the invention. Both FIGS. 5 and 6 are explained together below.

Steps 101 to 104 are optional for the further method and are described using the example of the terminal M1. In the optional steps 101 and 102, a coin data record is requested and provided by the issuer entity 1—in this case to the first terminal M1—after the electronic coin data record has been created. A signed masked electronic coin data record is sent to the monitoring entity 2 in step 103. In step 103, the received electronic coin data record Cᵢ is masked in accordance with Equation (3) and as explained in FIG. 1. Then, in step 104, the masked electronic coin data record Zᵢ is registered in the monitoring entity 2. It could be envisioned that masked electronic coin data records are only valid in the monitoring entity when they are registered by a participant such as a terminal device or server. Alternatively, as explained in relation to FIG. 1, the masked electronic coin data record Zᵢ may already be registered in the monitoring entity 2 as a valid masked electronic coin data record after step 102. Optionally, the terminal M1 may switch the received electronic coin data record with step 104, as will be described in more detail in step 108.

In step 105, the coin data record Cᵢ is transmitted in the direct transaction layer 3 to the second terminal M2. In the optional steps 106 and 107, a validity check is carried out with previous masking, wherein the monitoring entity 2 confirms the validity of the coin data record Zᵢ or Cᵢ in case of success.

In step 108, a received coin data record Cₖ is switched (the received coin data record Cᵢ could of course also be switched) to a new coin data record Cₗ, whereby the coin data record Cₖ becomes invalid and double spending is prevented. For this purpose, the monetary amount νₖ of the transmitted coin data record Cₖ is used as the “new” monetary amount νₗ. In addition, as already explained with Equations (14) to (17), the concealment amount rₗ is created. The additional concealment amount rₐₘ is used to prove that no new money (in the form of a higher monetary amount) was generated by the second terminal M2. Then, among other things, the masked coin data record Zₗ to be switched is sent to the monitoring entity 2 and the switch from Cₖ to Cₗ is instructed.

The corresponding check is carried out in the monitoring entity 2 in step 108′. Zₖ is entered in column 22a according to the table in FIG. 2 and the coin data record Zₗ to be rewritten is entered in column 23b. Then, a check in the monitoring entity 2 as to whether Zₖ is (still) valid, i.e. whether the last processing of Zₖ is entered in one of the columns 23a/b (as proof that Zₖ was not further split or deactivated or joined) and whether a check for the last processing failed. In addition, Zₗ is entered in column 23b and the markings in columns 25, 26, 27 are initially set to “0”. A check is now carried out as to whether Zₗ is valid, in which case the check according to Equations (16) and (17) may be used. In case of success, the marking in column 25 is set to “1”, otherwise to “0”. A check is now carried out, and the calculation according to Equation (10) shows that Zₖ and Zₗ are valid and the marking in column 26 is set accordingly. It is also checked whether the ranges are coherent, and then the marking in column 27 is set. If all three checks were successful and this was accordingly committed in the monitoring entity 2, the coin data record is considered to be switched. This means that the coin data record Cₖ is no longer valid and the coin data record Cₗ is valid from now on. Double spending is no longer possible if a third terminal M3 asks the monitoring entity 2 about the validity of the (doubly dispensed) coin data record.

In general—different from the illustration in FIG. 5—the electronic coin data records Cᵢ created by the issuer entity are transmitted (issued) to an entity (such as server, computer, . . . ) of a commercial bank. The (server) entity of the commercial bank provides the electronic coin data records for terminals. The terminal M1 requests and then receives the electronic coin data record from the entity of the commercial bank in steps 101 and 102. In particular, when the terminal M1 requests and receives the electronic coin data record Cᵢ from a server of a commercial bank, already switching in step 104 is useful.

In step 109, two-coin data records Cₖ and Cᵢ are joined to form a new coin data record Cₘ, as a result of which the coin data records Cₖ, Cᵢ become invalid and double spending is prevented. For this purpose, the monetary amount Urn is formed from the two monetary amounts νₖ and νᵢ. For this purpose, the concealment amount rₘ is formed from the two concealment amounts rₖ and rᵢ. In addition, the masked coin data record to be joined is obtained by means of Equation (3) and it (together with other information) is sent to the monitoring entity 2 and the joining is requested as processing.

In step 109′ the corresponding check is carried out in the monitoring entity 2. In this case, Zₘ is entered in column 23b according to the table in FIG. 2. The monitoring entity 2 then checks whether Zₖ and Zᵢ are (still) valid, i.e. whether the last processing of Zₖ or Zᵢ is entered in one of the columns 23a/b (as proof that Zₖ and Zᵢ are not further split or deactivated or joined) and whether a check for the last processing failed. In addition, the markings in columns 25, 26, 27 are initially set to “0”. A check is now made as to whether Zₘ is valid, in which case the check according to Equations (16) and (17) may be used. In case of success, the marking in column 25 is set to “1”, otherwise to “0”. A check is now carried out, and the calculation according to Equation (10) shows that Zᵢ plus Zₖ is equal to Zₘ and the marking in column 26 is set accordingly. It is also checked whether the ranges are consistent, and then the marking in column 27 is set.

In step 110, a coin data record Cᵢ is split into two partial coin data records Cₖ and Cⱼ, whereby the coin data record Cᵢ is made invalid and the two split partial coin data records are to be made valid. For this purpose, the monetary amount νᵢ is split into the two monetary amounts νₖ and νⱼ. For this purpose, the concealment amount r is split into the two concealment amounts rₖ and rⱼ. In addition, the masked partial coin data records Zₖ and Zⱼ are obtained by means of Equation (3) and these are sent with additional information, for example the range proofs, to the monitoring entity 2 and the splitting is requested as processing.

In step 110′, the corresponding check is carried out in the monitoring entity 2. Zⱼ and Zₖ are entered in the columns 23a/b according to the table in FIG. The monitoring entity 2 then checks whether Zᵢ is (still) valid, i.e. whether the last processing of Zᵢ is entered in one of the columns 23a/b (as proof that Zᵢ has not been further split or deactivated or joined) and whether a check for the last processing failed. In addition, the markings in columns 25, 26, 27 are initially set to “0”. A check now takes place as to whether Zⱼ and Zₖ are valid, in which case the check according to Equations (16) and (17) may be used. n case of success, the marking in column 25 is set to “1”. A check is now carried out, and the calculation according to Equation (10) shows that Zᵢ is equal to Zₖ plus Zⱼ and the marking in column 26 is set accordingly. It is also checked whether the ranges are consistent, and then the marking in column 27 is set.

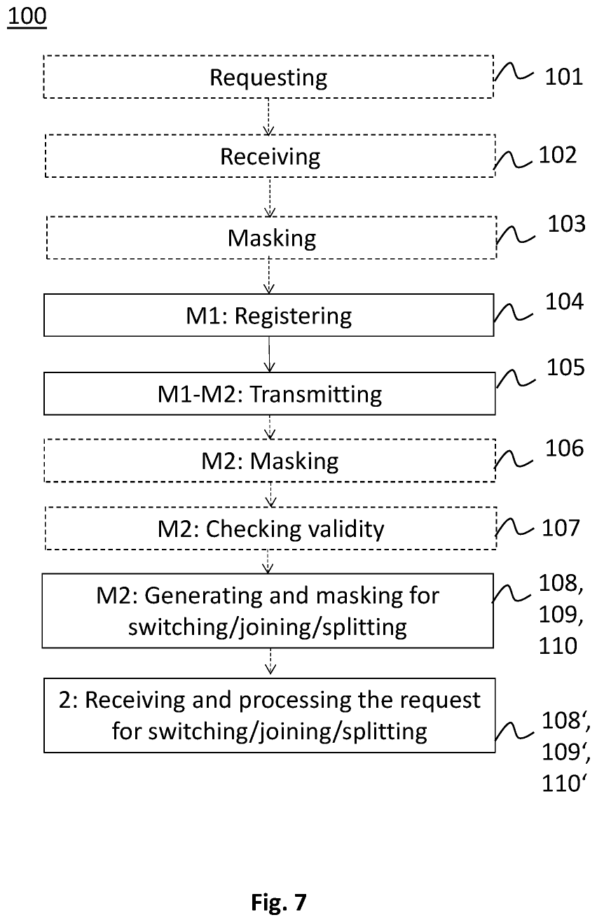

FIG. 7 once again shows an overview of the method steps 101-110′ in one sequence. From the point of view of the second terminal M2, an electronic coin data record which was registered 104 by the terminal M1 is received 105. With this electronic coin data record, a further (modified) electronic coin data record for switching, joining or splitting is generated and masked 108-110. The corresponding registration request is sent to the monitoring entity, which receives and processes it 108′-110′. Implementations of these steps and the steps shown in dashed lines, which are optional in the various variants, have already been adequately described

Within the scope of the invention, all elements described and/or drawn and/or claimed may be combined with one another as desired.

1.-22. (canceled)

23. A method for directly transmitting an electronic coin data record between a first and a second terminal, comprising the following steps by the second terminal:
receiving the electronic coin data record from the first terminal, the at least one electronic coin data record including a monetary amount and a concealment amount;
generating a modified electronic coin data record using the received electronic coin data record;
masking the modified electronic coin data record by applying a homomorphic one-way function to the modified electronic coin data record in order to obtain a masked modified electronic coin data record; and
sending a registration request for the masked modified electronic coin data record to a monitoring entity.

24. The method according to claim 23, wherein said registration request includes the masked modified electronic coin data record as a masked electronic coin data record to be registered and a masked received electronic coin data record as a registered masked electronic coin data record for the received electronic coin data record, and is in a registration request for switching, splitting or joining masked electronic coin data records.

25. The method according to claim 23, wherein in the step of generating
the modified electronic coin data record to be switched is generated from the received electronic coin data record, or
the received electronic coin data record is split into at least two split modified electronic coin data records, or
the received electronic coin data record as a first electronic coin data record and at least one second electronic coin data record are joined to form the joined modified electronic coin data record; and
said registration request accordingly includes:
exactly one masked electronic coin data record to be registered and exactly one registered masked electronic coin data record, or
at least two masked split modified electronic coin data records to be registered, or
at least two registered masked electronic coin data records.

26. The method according to claim 23, wherein in the step of generating:
the received electronic coin data record is switched to the modified electronic coin data record, wherein
a concealment amount for the modified electronic coin data record is generated using a received concealment amount of the received electronic coin data record, and
the received monetary amount of the received electronic coin data record is used as a monetary amount for the modified electronic coin data record; or
the received electronic coin data record is split into at least two electronic coin part data records, wherein
the received monetary amount corresponds to the sum of the monetary amounts of the at least two electronic coin part data records, and
the sum of the concealment amounts of the at least two electronic coin part data records correspond to the concealment amount of the received electronic coin data record; or
the received electronic coin data record as a first electronic coin data record and at least one second electronic coin data record are joined to form the modified joined electronic coin data record by
calculating a concealment amount for the modified electronic coin data record by forming the sum of the respective concealment amounts of the first and second electronic coin data records, and
calculating the monetary amount for the modified electronic coin data record by forming the sum of the respective monetary amounts of the first and second electronic coin data records.

27. The method according to claim 22, comprising masking the received electronic coin data record by applying the homomorphic one-way function to the received electronic coin data record in order to obtain the masked received electronic coin data record.

28. The method according to claim 23, wherein the monitoring entity stores valid masked electronic coin data records for electronic coin data records so that the second terminal can check the validity of a received electronic coin data record by sending the masked received electronic coin data record to the monitoring entity.

29. The method according to claim 23, further comprising a step of creating a proof that the monetary amount of the received electronic coin data record is equal to the monetary amount of the electronic coin data record to be switched.

30. A method in a monitoring entity which stores valid masked electronic coin data records formed by applying a homomorphic one-way function to an electronic coin data record, electronic coin data records including a monetary amount and a concealment amount, said method comprising the steps of:
receiving a registration request comprising at least one masked electronic coin data record to be registered and at least one registered masked electronic coin data record;
checking the registration request received, wherein
it is checked whether the registered masked electronic coin data record of the registration request is stored as a valid masked electronic coin data record in the monitoring entity, and
it is checked whether the masked electronic coin data records of the registration request are monetarily amount-neutral overall;
storing the masked electronic coin data record to be registered as a valid masked electronic coin data record, wherein the registered masked electronic coin data record of the registration request that was previously stored as valid is no longer valid.

31. The method according to claim 30, wherein checking the monetary amount neutrality of the registration request—due to the homomorphic one-way function used—is carried out without knowledge of the amount by forming the difference between the masked electronic coin data records.

32. The method according to claim 30, wherein the monitoring entity receives creation and/or deactivation requests from an issuer entity, for an electronic coin data record newly issued by said issuer entity and/or for an electronic coin data record withdrawn by said issuer entity, respectively.

33. The method according to claim 32, wherein the creation and/or deactivation request for a masked electronic coin data record comprises a signature of the issuer for the masked electronic coin data record,
wherein the signature of the masked newly created electronic coin data record is stored in the monitoring entity.

34. The method according to claim 23, wherein an electronic coin data record becomes invalid by marking or deleting the corresponding masked electronic coin data record in the monitoring entity,
wherein the corresponding masked electronic coin data record or the corresponding electronic coin data record is also deactivated in said issuer entity.

35. The method according to claim 23, wherein the monitoring entity is a decentrally controlled database, called Distributed Ledger Technology, DLT, in which the masked electronic coin data records are registered with corresponding processing information of the masked electronic coin data record.

36. A payment system for the exchange of monetary amounts, in which a method according to claim 23 is carried out, said payment system comprising:
a monitoring layer including a database, which is controlled in a decentralized manner and in which valid masked electronic coin data records for electronic coin data records are stored; and
a direct transaction layer including at least two terminals which exchange electronic coin data records.

37. A currency system, comprising an issuer entity, a monitoring entity, a first terminal and a second terminal, said issuer entity being configured to create an electronic coin data record,
wherein the monitoring entity is configured to carry out a method according to claim 30 and/or the first and second terminals reconfigured to carry out a method for directly transmitting an electronic coin data record between a first and a second terminal, comprising the following steps by the second terminal:
receiving the electronic coin data record from the first terminal, the at least one electronic coin data record including a monetary amount and a concealment amount;
generating a modified electronic coin data record using the received electronic coin data record;
masking the modified electronic coin data record by applying a homomorphic one-way function to the modified electronic coin data record in order to obtain a masked modified electronic coin data record; and
sending a registration request for the masked modified electronic coin data record to a monitoring entity.

38. The currency system according to claim 37, wherein only said issuer entity is authorized to create an electronic coin data record to be newly issued,
wherein said issuer entity provides a masked created electronic coin data record with a signature and sends the masked created electronic coin data record and the signature to the monitoring entity.

39. The currency system according to claim 37, wherein the monitoring entity executes creation and/or deactivation requests of said issuer entity for masked electronic coin data records and registration requests for masked modified electronic coin data records of other entities such as the two terminals.

40. The currency system according to one of claim 37, wherein the currency system comprises further coin owner entities, in server entities, which transmit electronic coin data records directly, among each other or from/to terminals, and which send registration requests for masked modified electronic coin data records to the monitoring entity.

41. The currency system according to claim 37, wherein steps are carried out by the second terminal by the steps being carried out in the terminal or by the terminal calling a terminal service which executes in the steps of generating, masking and/or sending for the terminal.

42. The currency system according to claim 37, wherein, in the checking entity, the masked electronic coin data record is recognized as valid when the masked electronic coin data record or its predecessor originates from said issuer entity,
wherein the issuer signature of created masked electronic coin data records is stored in the monitoring entity.

43. The currency system according to claim 37, wherein the checking entity and the issuer entity are implemented as a server entity, as a computer program product on a server and/or a computer.

44. The currency system according to claim 37, wherein the first and/or second terminal is configured as a mobile terminal, as a smartphone, a tablet computer, a computer, a machine, and/or as a passive terminal, as a smart card or wearable.
